(19) United States
(12) Patent Application Publication
(10) Pub. No.: US 2014/0248518 A1
(43) Pub. Date: Sep. 4, 2014

(54) POWER SUPPLY DEVICE

(71) Applicant: YAZAKI CORPORATION, Tokyo (JP)

(72) Inventor: Nobuaki YOSHIOKA, Kakegawa-shi (JP)

(73) Assignee: YAZAKI CORPORATION, Tokyo (JP)

(21) Appl. No.: 14/278,728

(22) Filed: May 15, 2014

Related U.S. Application Data
(63) Continuation of application No. PCT/JP2012/007295, filed on Nov. 14, 2012.

(30) Foreign Application Priority Data
Nov. 16, 2011 (JP) 2011-250504

(51) Int. Cl. H01M 10/48

(52) U.S. Cl. CPC H01M 10/482
USPC 429/90

(57) ABSTRACT

A power supply device comprises: a battery assembly including stacked battery cells, the battery cells having electrodes, the electrodes of the adjacent battery cells being placed opposite to one another; and a battery linking body disposed on a side at which the electrodes of the battery assembly 1 protrude, the battery linking body being configured to cover the protruding electrodes, the battery linking body including a substrate with a circuit pattern for voltage detection, the circuit pattern being directly connected to the electrodes placed opposite to one another.

### CROSS REFERENCE TO RELATED APPLICATIONS

This application is a continuation application of International Application No. PCT/JP2012/007295, filed on Nov. 14, 2012, which claims priority to Japanese Patent Application No. 2011-250504, filed on Nov. 16, 2011, the entire contents of which are incorporated by references herein.

### BACKGROUND OF THE INVENTION

1. Field of the Invention

The present invention relates to a power supply device having stacked battery cells.

2. Description of the Related Art

Hybrid vehicles, electric vehicles and the like have a power supply device as a power source for driving an electric motor. Japanese Patent Application Laid-Open Publication 2010-55885 discloses such a power supply device as a conventional one. As shown in FIGS. 8 and 9, this power supply device 50 includes a battery assembly 51. The battery assembly 51 has stacked battery cells 52 that are arranged in two rows. Each battery cell 52 has a pair of electrodes (i.e. positive and negative electrodes) 52a and 52b provided on an upper surface thereof in protruding manner. Each pair of electrodes 52a and 52b of the adjacent battery cells 52 and 52 are electrically connected by a link terminal 53 and two clamp terminals 54 and 55. The link terminal 53 is formed as a part of a bus bar, and has a pair of linking contacts 53a and 53b. The linking contacts 53a and 53b are oriented corresponding to orientations of the electrodes 52a and 52b to be linked thereto. The clamp terminals 54 and 55 are formed as parts of a bus bar. The clamp terminal 54 clamps the electrode 52a of the batter cell 52 and the electrode 53a of the link terminal 53. The clamp terminal 55 clamps the electrode 52b of the batter cell 52 and the electrode 53b of the link terminal 53. A fork-shaped terminal 54A is integrally provided with the clamp terminal 54. A voltage checking wire W is pressed into the fork-shaped terminal 54A to electrically connect thereto. The link terminal 53 and the clamp terminals 54 and 55 are integrally fixed by a mounting member 56 which is made of synthetic resin.

In the conventional technique as described above, the battery cells 52 of the battery assembly 51 are connected in a series by the link terminal 53 and clamp terminal 54 and 55. Information on a voltage on the electrode of each battery cell 52 is output through the voltage checking wire W connected to the fork-shaped terminal 54a. Accordingly, an output status of each battery cells 52 can be detected.

### SUMMARY OF THE INVENTION

In the above conventional technique, the voltage checking wire W, the link terminal 53, the clamp terminals 54 and 55, and the mounting member 56 are used both to connect electrodes of adjacent battery cells 52 and 52 and to acquire the information on the voltages thereon. The voltage checking wire W, the link terminal 53, the clamp terminals 54 and 55, and the mounting member 56 are needed for every connection point of the adjacent electrodes. Therefore, the numbers of components, the assembling operations thereof and the like increase with increasing the number of battery cells 52 to be used. In addition, a space for setting the link terminal 53 and the clamp terminals 54 and 55 is needed for the every connection point. This unnecessarily causes the power supply device 50 to be larger and heavier.

The present invention has been made in order to solve the above problems, and the object thereof is to provide a power supply device which is capable of suppressing increase of the numbers of components and assembling operations thereof, and also which is capable of being miniaturized and being reduced in its weight and cost.

An aspect of the present invention is a power supply device comprising: a battery assembly including stacked battery cells, the battery cells having electrodes, the electrodes of the adjacent battery cells being placed opposite to one another; and a battery linking body disposed on a side at which the electrodes of the battery assembly protrude, the battery linking body being configured to cover the protruding electrodes, the battery linking body including a substrate with a circuit pattern for voltage detection, the circuit pattern being directly connected to the electrodes placed opposite to one another by ultrasonic waves or lasers.

The substrate may be provided with at least one electrode insertion hole at a position corresponding to the electrodes placed opposite to one another. The electrodes may be inserted into the electrode insertion hole. End portions thereof may protrude from the electrode insertion hole. The end portions may be bent toward the circuit pattern so as to overlap one another. The end portions may be directly connected to the circuit pattern.

The circuit pattern may include a land for electrode in the vicinity of the electrode insertion hole.

According to the present invention, the connections between the electrodes in respective pairs and the acquisition of the information on the voltages thereon can be achieved only by the substrate. That is, the number of the components can be reduced compared with the conventional technique. There is no component necessarily required for every connection point of the paired electrodes, and thus the substrate can be set in a small space. Therefore, even if the number of the battery cells increase, it is possible to suppress increase of the numbers of the components and assembling operations thereof, as lower as possible. Thus, it is possible to miniaturize the device and reduce its weight and cost.

### BRIEF DESCRIPTION OF THE DRAWINGS

FIG. 1 is a perspective view illustrating a power supply device according to an embodiment of the present invention.

FIGS. 2A and 2B illustrate the embodiment of the present invention. FIG. 2A is a perspective view illustrating a main part of the power supply device in which some insulating covers are dismounted. FIG. 2B is a sectional view illustrating a connection state of paired electrodes and a circuit pattern of a substrate.

FIG. 3 is a perspective view illustrating a battery assembly according to the embodiment of the present invention.

FIGS. 4A and 4B illustrate the embodiment of the present invention. FIG. 4A is a perspective view illustrating a first battery cell, and FIG. 4B is a perspective view illustrating a second battery cell.

FIG. 5 is a perspective view illustrating a battery cell linking body according to the embodiment of the present invention, in which some insulating covers are dismounted.

FIG. 6 is a perspective view illustrating a battery cell linking body according to the embodiment of the present invention, in which all insulating covers are dismounted.

FIG. 7 is a perspective view illustrating the embodiment in a state where the battery cell linking body is arranged at one side of the battery assembly, and electrodes are inserted into respective electrode insertion holes of the substrate.

FIG. 8 is an exploded perspective view of a conventional power supply device.

FIG. 9 is an expanded perspective view illustrating a main part of the conventional power supply device.

### DESCRIPTION OF THE PREFERRED EMBODIMENTS

Hereinafter, an embodiment of the present invention is described with reference to the drawings.

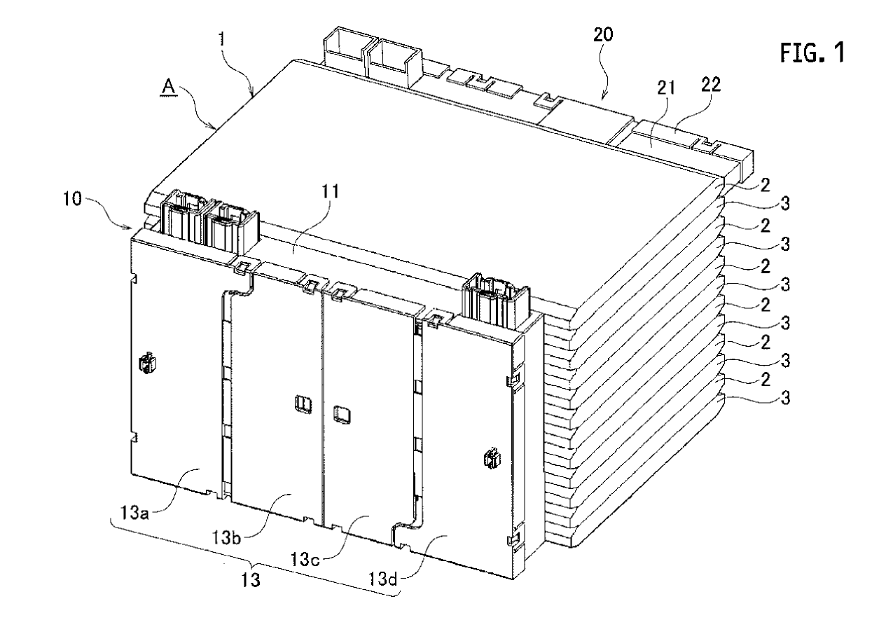

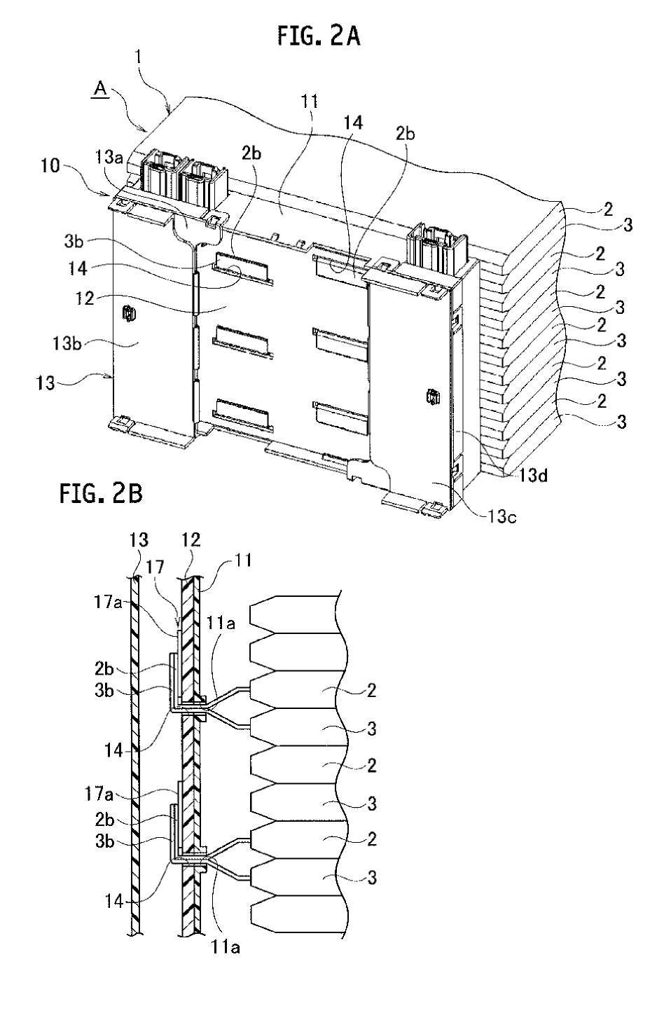

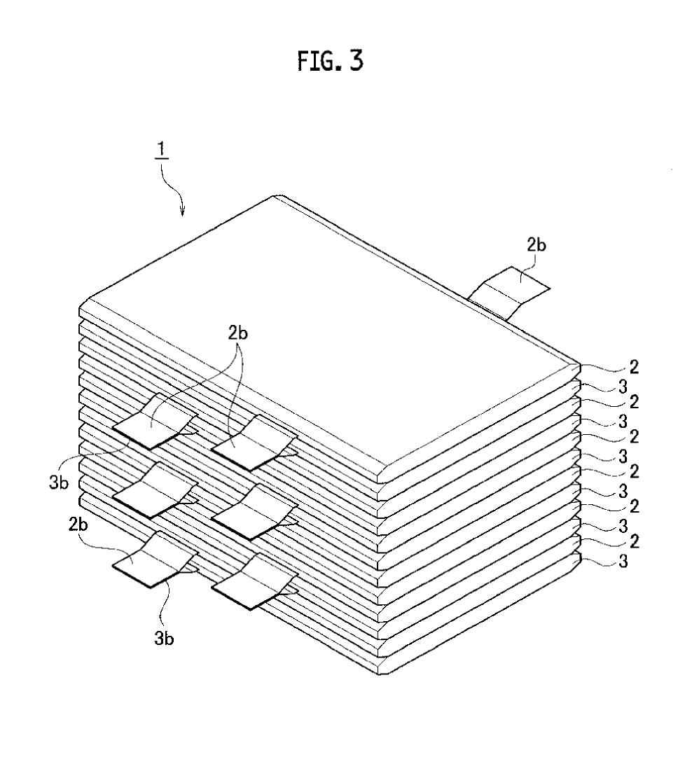

FIGS. 1 to 7 illustrate a first embodiment of the present invention. As illustrated in FIGS. 1 and 2A, a power supply device A comprises: a battery assembly 1 including stacked battery cells 2 and 3 (total twelve cells in this embodiment, for example); and a pair of battery linking bodies 10 and 20 disposed on both sides of the battery assembly 1.

As illustrated in FIG. 3 in detail, the battery assembly 1 comprises twelve battery cells 2 and 3. Hereinafter, the battery cell 2 is referred to a first battery cell 2, and the battery cell 3 is referred to a second battery cell 3. The first battery cell has electrodes 2b, and the second battery cell has electrodes 3b. The positions of the electrodes 2b and 3b are different to each other.

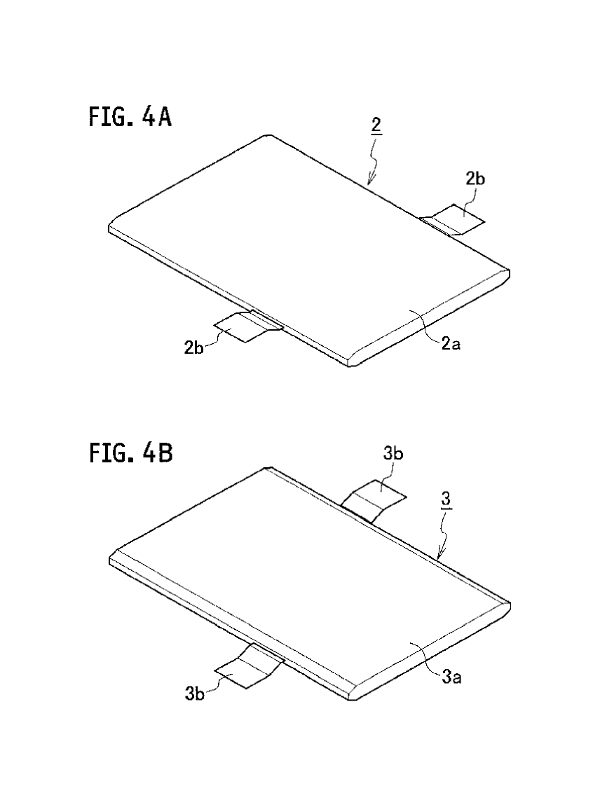

As illustrated in FIG. 4A, the first battery cell 2 includes a battery cell main body 2a formed into a rectangular and flat shape, a pair of electrodes (i.e. positive and negative electrodes) 2b and 2b respectively protruding from left and right side surfaces of the battery cell main body 2a. One of the paired electrodes 2b and 2b protrudes at the front side of the battery cell main body 2a, and the other one protrudes at the back side thereof. Both electrodes 2b and 2b are arranged at the same side of the battery cell main body 2a with reference to a center line of the battery cell main body 2a. That is, even when the battery cell main body 2a is flipped so that its front side is arranged to the backside or vice versa, the paired electrodes 2b and 2b are located at the same positions in a plan view except that their original left and right positions are reversed. Each electrode 2b is formed into a thin film, thin plate or the like.

As illustrated in FIG. 4B, the second battery cell 3 includes a battery cell main body 3a formed into a rectangular and flat shape, a pair of electrodes (i.e. positive and negative electrodes) 3b and 3b respectively protruding from left and right side surfaces of the battery cell main body 3a. One of the paired electrodes 3b and 3b protrudes at the front side of the battery cell main body 3a, and the other one protrudes at the back side thereof. Both electrodes 3b and 3b are arranged at the same side of the battery cell main body 3a with reference to a center line of the battery cell main body 3a. That is, even when the battery cell main body 3a is flipped so that its front side is arranged to the backside or vice versa, the paired electrodes 3b and 3b are located at the same positions in a plan view except that their original left and right positions are reversed. Each electrode 3b is formed into a thin film, thin plate or the like.

As illustrated in FIG. 3, the first and second battery cells 2 and 3 having the above configurations are alternately stacked. In this case, the electrodes 2b and 3b of the adjacent first and second battery cells 2 and 3, which have opposite polarities, are placed opposite to each other in contact with one another. Accordingly, in the battery assembly 1, the twelve battery cells 2 and 3 are connected in series.

As illustrated in FIGS. 2A, 2B, 5 and 6 in detail, the battery linking body 10 comprises: an insulating case main body 11; a substrate 12 disposed in a frame of the insulating case main body 11; an insulating cover 13 covering a space in the frame of the insulating case main body 11 from the outside.

The insulating case main body 11 is provided with electrode insertion holes 11a. The electrode insertion holes 11a open at six positions corresponding to the electrodes 2b and 3b protruding from one side of the battery assembly 1.

The substrate 12 is provided with electrode insertion holes 14. The electrode insertion holes 14 open at positions corresponding to the paired electrodes 2b and 3b protruding from the one side of the battery assembly 1. That is, the electrode insertion holes 14 are located at the same positions of the electrode insertion holes 11a of the insulating case main body 11.

A circuit pattern 17 for voltage detection (see FIG. 2B) is formed on the substrate 12. The circuit pattern 17 includes lands 17a for electrode in the vicinity of respective electrode insertion holes 14.

As illustrated in FIGS. 2A and 2B in detail, the paired electrodes 2b and 3b, which protrude from the one side of the battery assembly 1, are inserted into the electrode insertion holes 11a and 14 of the insulating case main body 11 and the substrate 12. With this insertion, the end portions of the paired electrodes 2b and 3b are protruded and exposed from the electrode insertion hole 14. Thereafter, the end portions are bent toward the land 17a so as to overlap one another, and are connected thereto by a connection method using ultrasonic waves, lasers or the like. That is, the substrate 12 is mounted in a residual space in the insulating case main body 11, which is not occupied by the electrodes 2b and 3b. In addition, the electrodes 2b and 3b are directly connected to the substrate 12 without use of any terminals or the like. Accordingly the battery linking body 10 can be miniaturized, and the mounting area of the substrate 12 can be expanded.

As described below, the information on voltages on the electrodes 2b and 3b at both sides of the battery linking bodies 10 and 20 is sent to the substrate 12. The substrate 12 has a circuit for detecting abnormal voltages of the battery cells 2 and 3. This circuit determines whether or not the output voltages of the battery cells 2 and 3 are abnormal.

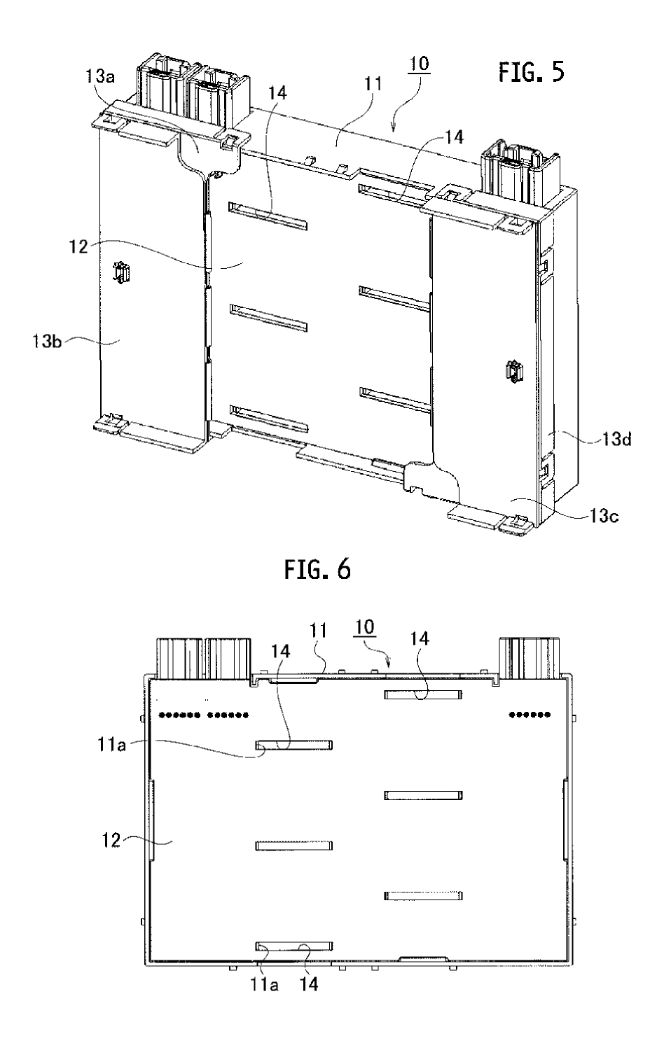

The insulating cover 13 is composed of four divided covers 13a to 13d. The divided covers 13a and 13d constitute side parts of the insulating cover 13, and are attached to the insulating case main body 11. The divided covers 13b and 13c constitute middle parts of the insulating cover 13, and pivotally supported to the divided covers 13a and 13d, respectively. As illustrated in FIGS. 2A and 5, when the divided covers 13b and 13c are positioned at the open position, the six electrode insertion holes 14 come to be exposed. When the divided covers 13b and 13c are positioned at the close position, an accommodation space for the substrate 12 is covered (closed). When the divided covers 13b and 13c are at the close position, they are attached to the insulating case main body 11. Accordingly, the battery linking body 10 electrically insulates the electrode 2b and 3b that protrude from the one side of the battery assembly 1.

The battery linking body 20 has a similar configuration of the battery linking body 10. The battery linking body 20 includes an insulating case main body 21 (see FIG. 1), an insulating cover 22 (also see FIG. 1), and a substrate (not shown). The battery linking body 20 electrically insulates the electrodes 2b and 3b that protrude from the other side of the battery assembly 1. The voltage information at the electrodes 2b and 3b disposed at the battery linking body 20 side are sent to the substrate 12 in the battery linking body 10 via a wire for voltage detection (not shown).

In the insulating case main body 21, a pair of output terminals (now shown) is provided. An output of the power supply device A is obtained from the pair of the output terminals.

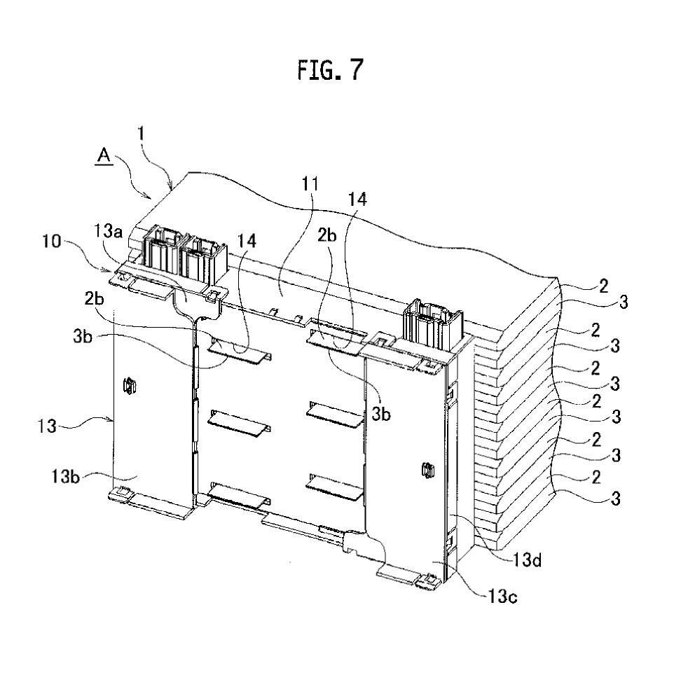

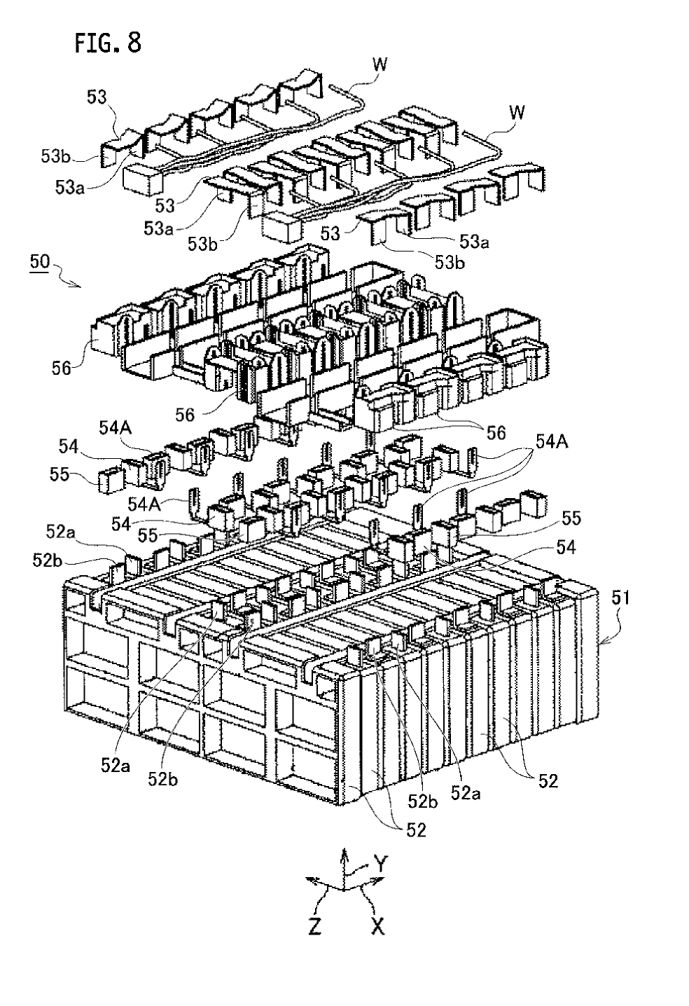

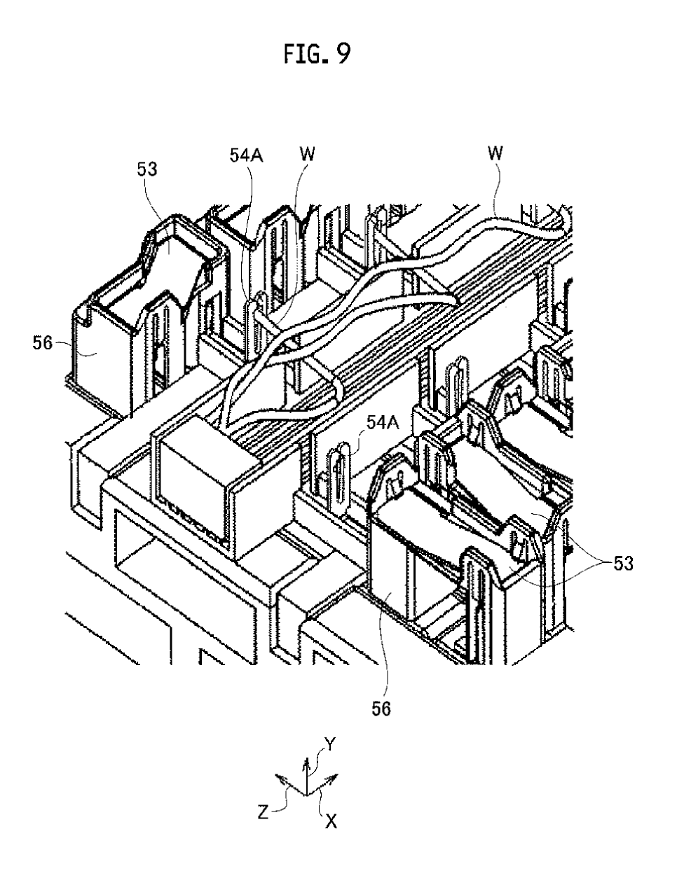

Next, an outline of the assembling operations of the power supply device A will be described. The battery linking body 10 is approached to the battery assembly 1 along a direction in which the battery linking body 10 faces the one side of the battery assembly 1, and each pair of the electrodes 2b and 3b is inserted into the corresponding electrode insertion holes 11a and 14 of the insulating case main body 11 and substrate 12. With this insertion, the end portions of the electrodes 2b and 3b in each pair are protruded and exposed to the outside of the substrate 12 (see FIG. 7). Next, the exposed end portions are bent toward the land 17a so as to overlap one another. Further, the end portions are connected to the land 17a by the connection method using ultrasonic waves, lasers or the like. Thereafter, the divided covers 13b and 13c are set at the close position, and attached to the insulating case main body 11.

The battery linking body 20 is assembled in a similar way to the assembling operation of the battery linking body 10 as described above.

As described above, the power supply device A according to the present embodiment comprises: the battery assembly 1, and the battery linking bodies 10 and 20. The battery linking body 10 includes the substrate 12. The substrate 12 includes at least one electrode insertion hole 14 and the circuit pattern 17 for voltage detection. The paired electrodes 2b and 3b placed opposite to each other are directly connected to the circuit pattern 17. Therefore, the connections between the electrodes 2b and 3b in respective pairs and the acquisition of the information on the voltages thereon can be achieved only by the substrate 12. Specifically, the connections and acquisition as described above can be achieved by fewer components than those of the conventional power supply device. In the present embodiment, there is no component necessarily required for every connection point of the paired electrodes, and thus the substrate 12 can be set in a small space. Therefore, even if the number of the battery cells 2 and 3 increase, it is possible to suppress increase of the numbers of the components and assembling operations thereof, as lower as possible. Thus, it is possible to miniaturize the device and reduce its weight and cost.

The substrate 12 includes the circuit for detecting the abnormal voltages of the battery cells 2 and 3. Accordingly, it is possible to further reduce the number of the components of the power supply device, thus further miniaturization and reduction of the weight and cost become possible.

The substrate 12 is provided with at least one electrode insertion hole 14. The paired electrodes 2b and 3b are inserted into the electrode insertion hole 14, the end portions thereof is protruded from the electrode insertion hole 14. The end portions are bent toward the circuit pattern 17 so as to overlap one another, and are directly connected to the circuit pattern 17. Accordingly, when the battery linking body 10 is mounted to the battery assembly 1, a connection point of the electrodes 2b and 3b is positioned at the outside of the battery linking body 10. Consequently, the operation to connect the paired electrodes 2b and 3b to the circuit pattern 17 is improved.

The circuit pattern 17 includes lands 17a for electrode in the vicinity of respective electrode insertion holes 14. Accordingly, the lengths of the electrodes can be short.

What is claimed is:

1. A power supply device comprising:
a battery assembly including stacked battery cells, the battery cells having electrodes, the electrodes of the adjacent battery cells being placed opposite to one another; and
a battery linking body disposed on a side at which the electrodes of the battery assembly protrude, the battery linking body being configured to cover the protruding electrodes, the battery linking body including a substrate with a circuit pattern for voltage detection, the circuit pattern being directly connected to the electrodes placed opposite to one another by ultrasonic waves or lasers.

2. The power supply device according to claim 1, wherein
the substrate is provided with at least one electrode insertion hole at a position corresponding to the electrodes placed opposite to one another,
the electrodes are inserted into the electrode insertion hole, end portions thereof protrudes from the electrode insertion hole, the end portions are bent toward the circuit pattern so as to overlap one another, and
the end portions are directly connected to the circuit pattern.

3. The power supply device according to claim 2, wherein
the circuit pattern includes a land for electrode in the vicinity of the electrode insertion hole.

4. The power supply device according to claim 1, wherein the substrate includes a detection circuit for abnormal voltages of the battery cells.

5. The power supply device according to claim 2, wherein the substrate includes a detection circuit for abnormal voltages of the battery cells.

6. The power supply device according to claim 3, wherein the substrate includes a detection circuit for abnormal voltages of the battery cells.
